(19) United States
(12) Patent Application Publication
(10) Pub. No.: US 2009/0160772 A1
(43) Pub. Date: Jun. 25, 2009

(54) DIFFUSE OPTICS IN AN OPTICAL MOUSE

(75) Inventors: Mark DePue, Issaquah, WA (US); David Bohn, Fort Collins, CO (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/960,748

(22) Filed: Dec. 20, 2007

(51) Int. Cl. G06F 3/033

(52) U.S. Cl. 345/166

(57) ABSTRACT

Embodiments of diffuse optics in an optical mouse are disclosed. In one embodiment, an optical mouse comprises a light source configured to emit light toward a tracking surface, an image sensor, an optical diffuser disposed optically upstream of the tracking surface and configured to diffuse light from the light source that illuminates the tracking surface, and a controller configured to receive image data from the image sensor and to identify a tracking feature in the image data.

### BACKGROUND

An optical computer mouse uses a light source and image sensor to detect mouse movement relative to an underlying tracking surface to allow a user to manipulate a location of a virtual pointer on a computing device display. Two general types of optical mouse architectures are in use today: oblique architectures and specular architectures. Each of these architectures utilizes a light source to direct light onto an underlying tracking surface and an image sensor to acquire an image of the tracking surface. Movement is tracked by acquiring a series of images of the surface and tracking changes in the location(s) of one or more surface features identified in the images via a controller.

Optical mice generally utilize one of two types of light sources—light-emitting diodes (LEDs) and lasers such as diode lasers. An LED generally comprises a semiconductor die with a junction configured to emit light through a top surface of the die. An electrical lead is connected to the top surface of the die to allow electrical current to flow through the die. The lead may not be transparent to light emitted by the LED, and may cause fixed patterns to be imaged on the image sensor.

Semiconductor diode lasers generally emit coherent light from a side or top surface (as with a VCSEL laser) of a die. Due to the significant coherence length of laser light, fixed patterns on the image sensor may arise from interference patterns caused by beam spreading and imperfections in downstream optics. Such fixed patterns may harm mouse tracking performance.

### SUMMARY

Accordingly, various embodiments of optical mice are disclosed that may reduce the impact of fixed optical patterns on mouse tracking performance. In one embodiment, an optical mouse comprises a light source configured to emit light toward a tracking surface, an image sensor, an optical diffuser disposed optically upstream of the tracking surface and configured to diffuse light from the light source that illuminates the tracking surface, and a controller configured to receive image data from the image sensor and to identify a tracking feature in the image data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of an optical mouse.

FIG. 2 shows an embodiment of an optical architecture comprising a diffuse light source.

FIG. 3 shows an embodiment of an optical architecture illustrating a diffusing coating on a lens and an optical diffuser provided separately from a lens or light source.

FIG. 4 shows a graphical comparison of an optical intensity as a function of angle for a non-diffuse light source and a diffuse light source.

FIG. 5 shows an embodiment of an LED illustrating an LED die and an electrical lead bonded to the die.

FIG. 6 shows a graphical representation of a tracking feature and a fixed pattern imaged on an optical mouse image sensor.

FIG. 7 shows a graphical representation of peaks in a correlation function arising from the tracking feature and fixed pattern of FIG. 6.

FIG. 8 shows a graphical representation of a tracking feature imaged on an optical mouse image sensor in the absence of a fixed pattern.

FIG. 9 shows a graphical representation of a peak in a correlation function arising from the tracking feature of FIG. 8.

FIG. 10 shows a process flow depicting a method of tracking a motion of an optical mouse across a tracking surface.

### DETAILED DESCRIPTION

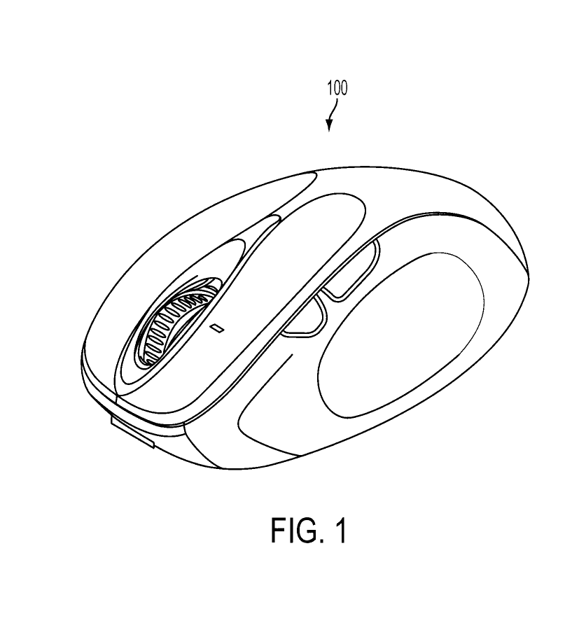

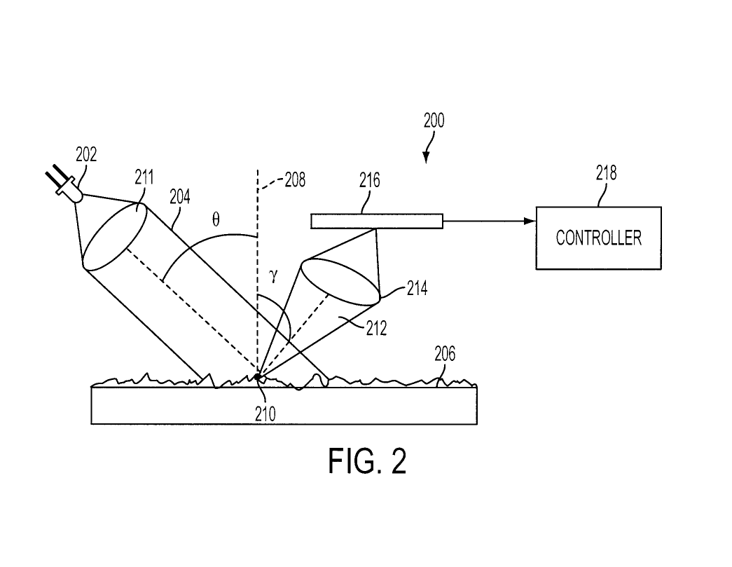

FIG. 1 shows an embodiment of an optical mouse 100, and FIG. 2 illustrates an embodiment of an optical architecture 200 for the optical mouse 100. The optical architecture 200 comprises a light source 202 configured to emit a beam of light 204 toward a tracking surface 206 such that the beam of light 204 is incident upon the tracking surface at a location 210. The beam of light 204 has an incident angle θ with respect to the normal 208 of the tracking surface 206. The optical architecture 200 may further comprise a collimating lens 211 disposed between the light source 202 and the tracking surface 206 for collimating the beam of light 204. While FIG. 1 depicts a portable mouse, it will be understood that the architecture depicted may be used in any other suitable mouse.

The optical architecture 200 is configured such that diffuse light is used to illuminate the tracking surface. For example, the light source 202 may be configured to output diffuse light, or the optical architecture 200 may comprise other elements disposed between the light source 202 and the tracking surface 206 to diffuse a beam of light emitted by the light source 206. The use of diffuse light to illuminate a tracking surface may help to reduce the presence of fixed optical patterns in the image focused on the image sensor, and therefore may help to improve tracking performance, as discussed in more detail below.

The embodiment of FIG. 2 has a specular optical configuration. In this configuration, some portion of the incident beam of light 204 reflects from the tracking surface 206, as indicated at 212, in a distribution about a specular reflection angle γ, which equals the incident angle θ. Some of the reflected light 212 is imaged by a lens 214 onto an image sensor 216 positioned at or near the specular reflection angle γ. Alternative embodiments may utilize an oblique optical architecture in which the light source is configured to emit an incident beam of light at an oblique angle to the tracking surface, and in which the image sensor is positioned approximately normal to the tracking surface, or at another suitable position relative to the tracking surface, to detect non-specular reflections. A mouse with a specular architecture may be configured to detect patches of specular reflection, which appear as bright patches in an image of a tracking surface, as tracking features. In contrast, a mouse with an oblique architecture may be configured to detect shadows in an image of the tracking surface, rather than patches of reflection, as tracking features.

The image sensor 216 is configured to provide image data to a controller 218. The controller 218 is configured to acquire a plurality of time-sequenced frames of image data from the image sensor 216, to process the image data to locate one or more tracking features in the plurality of time-sequenced images of the tracking surface, and to track changes in the location(s) of the plurality of time-sequenced images of the tracking surfaces to track motion of the optical mouse 100.

In some embodiments, the light source 202 is configured to emit light in or near a blue region of the visible spectrum. The terms “in or near a blue region of the visible spectrum”, as well as “blue”, “blue light” and the like, as used herein describe light comprising one or more emission lines or bands in or near a blue region of a visible light spectrum, for example, in a range of 400-490 nm. These terms may also describe light within the near-UV to near-green range that is able to activate optical brighteners, as described in more detail below. In other embodiments, the light source 202 may emit light in other portions of the visible and/or infrared spectrum, including but not limited to green, yellow, red, etc.

In various embodiments, the light source 202 may be configured to output incoherent light or coherent light, and may utilize one or more lasers, LEDs, OLEDs (organic light emitting devices), narrow bandwidth LEDs, or any other suitable light-emitting device. Further, in embodiments where the light source is configured to output blue light, the light source 202 may be configured to emit light that is blue in appearance, or may be configured to emit light that has an appearance other than blue to an observer. For example, white LED light sources may utilize a blue LED die (composed of InGaN, for example) either in combination with LEDs of other colors, in combination with a scintillator or phosphor such as cerium-doped yttrium aluminum garnet, or in combination with other structures that emit other wavelengths of light, to produce light that appears white to a user. In yet another embodiment, the light source 202 comprises a generic broadband source in combination with a band pass filter that passes a desired wavelength or band of light.

As mentioned above, the light source 202 may incorporate an optical diffuser configured to output diffuse light. Any suitable mechanism may be used to diffuse the light output by the LED or laser light source within the light source packaging. For example, in one embodiment, a light source comprising a LED die surrounded by a packing of small refractive beads in a polymer matrix may be used as light source 202. The refractive beads cause light within the light source to refract and/or reflect many multiples of times before leaving the light source packaging. The large number of refractions and reflections that occur smooth any peaks in the intensity of light emitted from the die as a function of angular position so that they are not imaged onto the image sensor, and also may help to eliminate fixed patterns caused by the light source. One example of such an LED is model number SLA560BDT from ROHM Co. Ltd. of Kyoto, Japan and San Diego, Calif. This LED comprises a plurality of small microspheres contained within an epoxy packaging surrounding the LED die. It will be appreciated that this is only one example of a diffuse LED light source, and that any other suitable diffuse light source may be used.

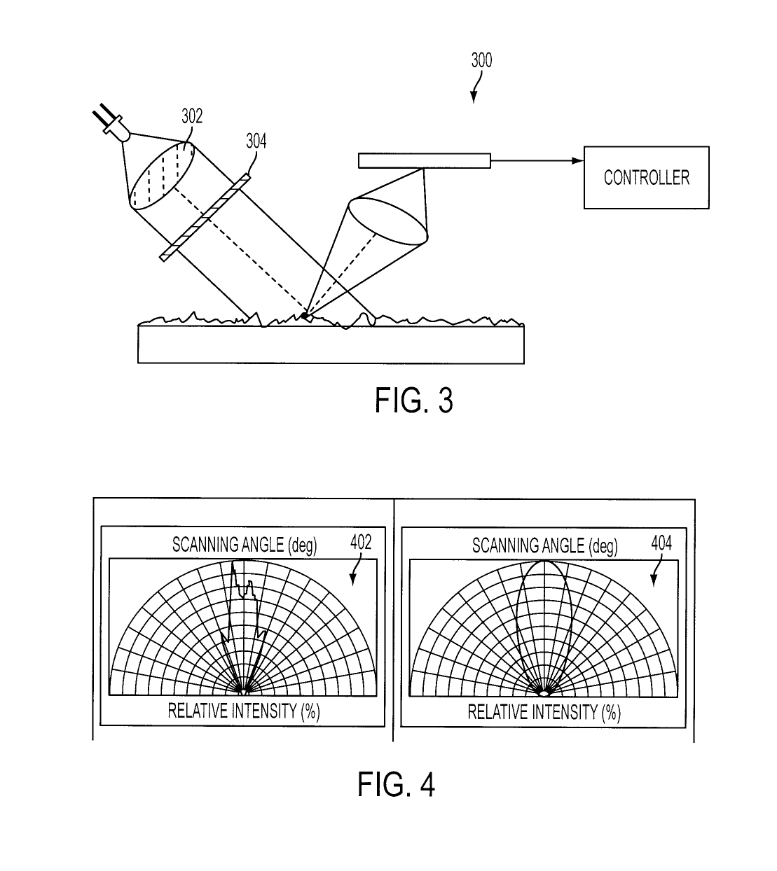

In other embodiments, downstream optics are used to diffuse light from a non-diffuse light source. FIG. 3 shows an embodiment of an optical system 300 that illustrates two alternative structures for diffusing light from a non-diffuse light source: a lens 302 comprising a diffusing surface, and a dedicated optical diffuser 304 provided separately from other optical components. A diffuse light optical system may comprise either of these elements, or both of these elements, alone or in combination with any other desired optical diffuser. An optical diffuser such as diffuser 304 generally comprises one or more diffusive elements such as ground glass, small beads/microspheres, opal glass, diffractive optics, etc., that smoothes variations in the intensity of a beam of light across the beam area.

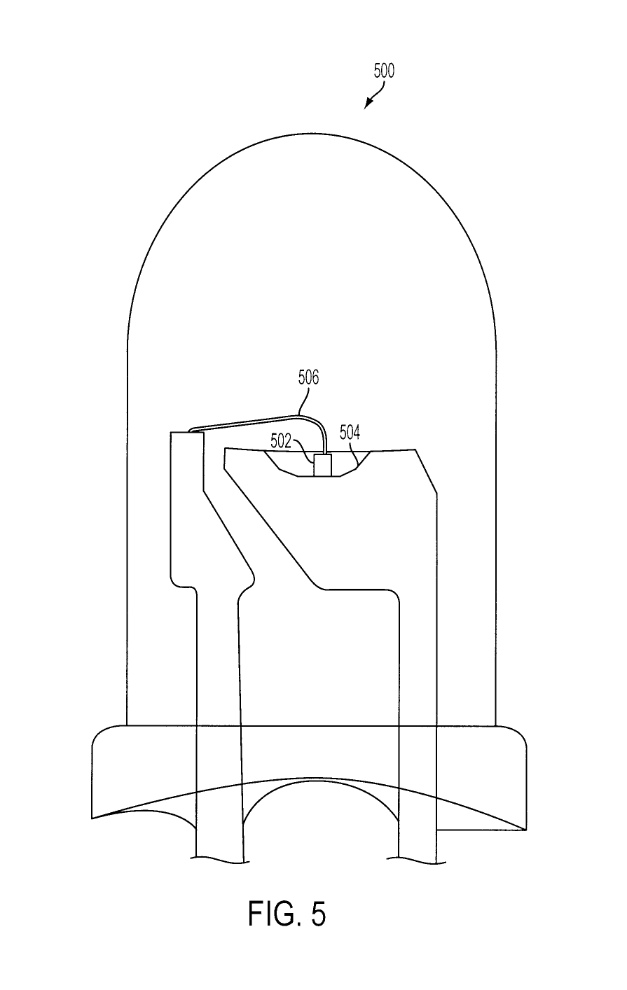

FIG. 4 shows a graphical comparison of an intensity of light emitted from an example non-diffuse LED and from an example diffuse-LED (containing microbeads embedded in epoxy) as a function of angle relative to the center of the emitted light beam. First referring to graph 402, a non-diffuse light source has peaks in the intensity spectrum. Such peaks 403 may arise from various factors. For example, referring briefly to FIG. 5, an example LED 500 is shown. LED 500 comprises a die 502 mounted within a reflector 504 configured to reflect light emitted from the die 502 out of the reflector. Further, an electrical lead 506 is connected to a top surface of the die 502.

Various characteristics of the LED 500 may lead to fixed patterns in the beam of light emitted by the LED 500. In the absence of a diffusing element to diffuse the light beam, these fixed patterns may be imaged on an image sensor, and therefore may harm mouse tracking performance. For example, the lead 506 may appear to the image sensor as a fixed spot in the image field. Likewise, the die 502 may be displaced from an intended position within the reflector 504 during manufacturing, which may cause variation in the cross-sectional intensity of the beam.

Referring again to FIG. 4, a graph of an intensity spectrum of a diffuse light source as a function of angle is shown at 404. Compared to the non-diffuse intensity spectrum 402, the diffuse intensity spectrum 404 comprises no abrupt peaks, but instead smoothly varies in intensity from the beam center toward the beam edges. Such a light beam may give rise to fewer fixed patterns on the image sensor, and therefore interfere less with the correlation function used to track mouse motion.

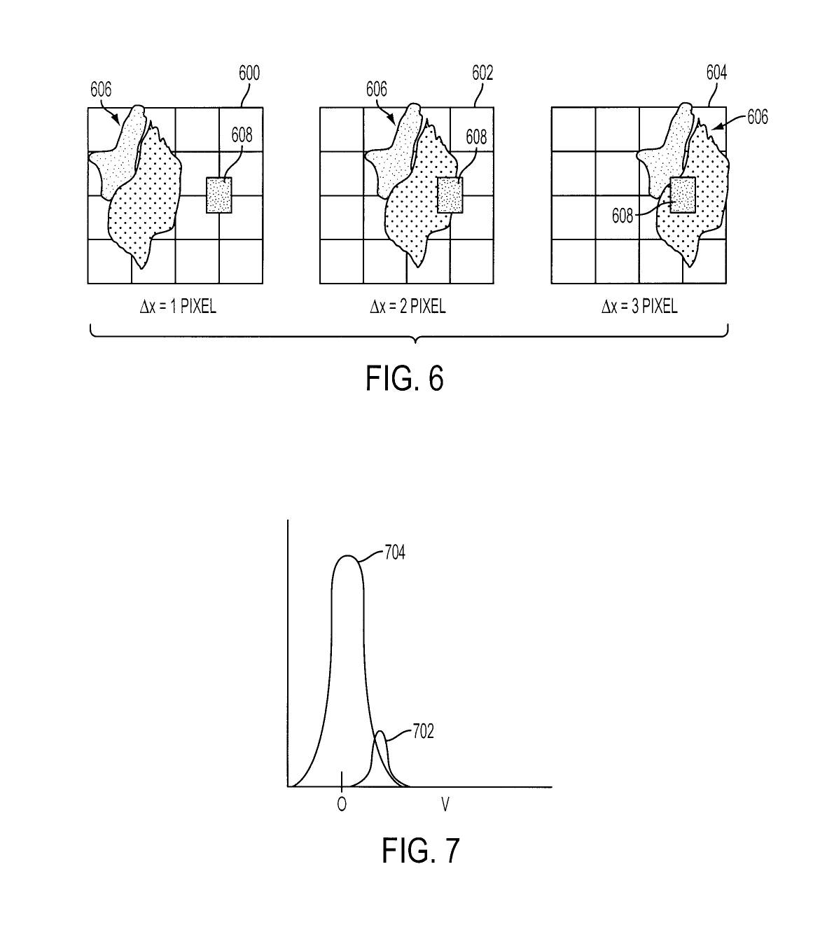

FIG. 6 shows a schematic depiction of an example of a fixed pattern in an image on an image sensor. Three time-sequenced images are shown at 600, 602 and 604 respectively. The grid lines shown in each image represent individual pixels of the image sensor. A tracking feature is shown at 606, and a fixed pattern (for example, due to an LED die bonding pad being imaged on the sensor) in the image is shown at 608. As the tracking feature 606 moves across the image sensor, it may be obscured by the fixed pattern 608, as can be seen in images 602 and 604. This may cause correlation functions used to determine the direction and velocity of the movement of the mouse to have difficulties in properly tracking motion. For example, as shown in FIG. 7, where the motion of the mouse is slow, a peak 702 in a velocity correlation function due to the movement of the tracking feature may overlap with a large peak 704 at a zero velocity position that is due to the fixed pattern. This may harm the ability of the mouse track slow, careful movements, and therefore may harm the performance of the mouse.

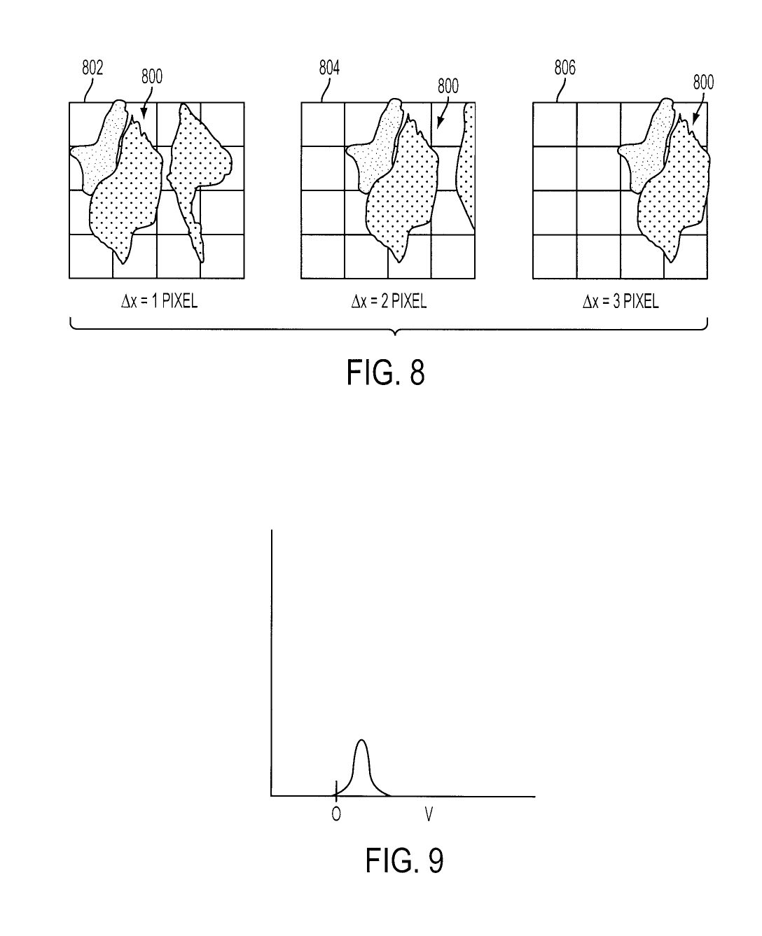

Referring next to FIGS. 8 and 9, in the absence of the fixed pattern shown in FIG. 6, a tracking feature 800 may be more easily tracked across a plurality of image frames 802, 804, 806 without interference. As shown in FIG. 9, without the large peak caused by the fixed pattern of FIG. 6, a peak 900 in the velocity correlation function at a low velocity is not obscured by a large peak at zero velocity. This allows good tracking of the mouse direction and velocity even at low velocities.

The use of diffuse light may lead to other advantageous features besides tracking performance. For example, the use of a diffuse light source may facilitate meeting eye safety standards. Eye safety standards, such as laser eye safety standard IEC 60825-1, quantify the photochemical and/or thermal risk posed by a light source using various factors such as the apparent source size of the source vs. the output energy of the source. For an LED with “hot spots” (i.e. peaks in the angular light intensity distribution) or for a laser, the presence of peaks in the intensity distribution may cause the apparent source size of the light source to be considered small for the safety calculations, and therefore may impact compliance with safety standards.

The use of diffusing optics to diffuse a light beam optically upstream of a tracking surface may help to increase the apparent source size of a light source, and therefore may decrease the energy level per source area. This may remove variations in individual LEDs caused by manufacturing tolerances, errors, etc. as a factor in determining the eye safety of a device, thereby facilitating compliance with eye safety standards. The use of a diffuse light source may be particularly helpful for blue light, as photochemical safety may be determined differently for different wavelengths.

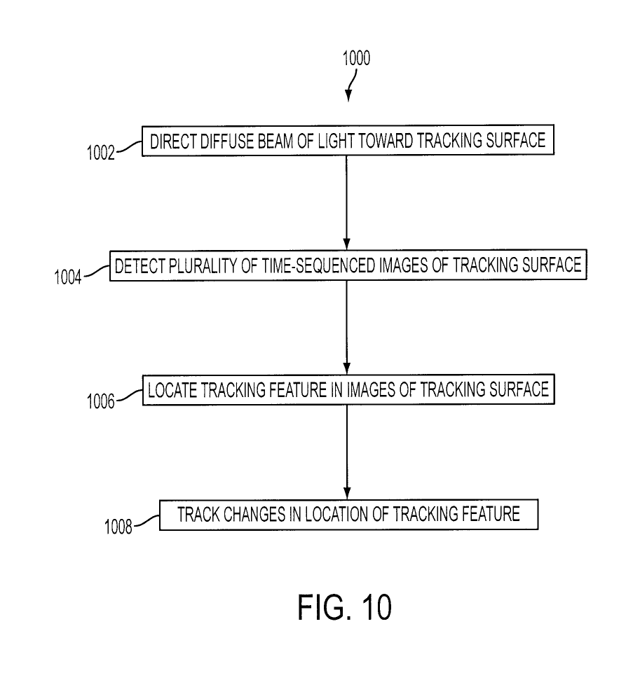

FIG. 10 shows a process flow depicting an embodiment of a method 1000 of tracking a motion of an optical mouse across a surface. Method 1000 comprises, at 1002, directing a diffuse incident beam of blue light toward a tracking surface, and detecting, at 1004, a plurality of time-sequenced images of the tracking surface via an image sensor configured to detect an image of the surface. Next, method 1000 comprises, at 1006, locating a tracking feature in the plurality of time-sequenced images of the tracking surface, and then, at 1008, tracking changes in the location of the tracking feature in the plurality of images. An (x,y) signal may then be provided by the optical mouse to a computing device for use by the computing device in locating a cursor or other indicator on a display screen. Through the use of diffuse light, problems caused by fixed patterns in the images detected by the image sensor may be lessened or even completely avoided.

It will be understood that the configurations and/or approaches described herein are exemplary in nature, and that these specific embodiments or examples are not to be considered in a limiting sense, because numerous variations are possible. The subject matter of the present disclosure includes all novel and nonobvious combinations and subcombinations of the various processes, systems and configurations, and other features, functions, acts, and/or properties disclosed herein, as well as any and all equivalents thereof.

1. An optical mouse, comprising:
a light source configured to emit light toward a tracking surface;
an image sensor;
an optical diffuser disposed optically upstream of the tracking surface and configured to diffuse light from the light source that illuminates the tracking surface; and
a controller configured to receive image data from the image sensor and to identify a tracking feature in the image data.

2. The optical mouse of claim 1, wherein the optical diffuser is incorporated as part of the light source.

3. The optical mouse of claim 1, further comprising a lens disposed between the light source and the tracking surface, and wherein the optical diffuser comprises a diffusing surface on the lens.

4. The optical mouse of claim 1, wherein the optical diffuser is provided as a dedicated optical element separate from the light source and any lenses.

5. The optical mouse of claim 1, wherein the light source comprises a light-emitting diode configured to emit blue light.

6. The optical mouse of claim 1, wherein the light source comprises a light-emitting diode configured to emit white light.

7. The optical mouse of claim 1, wherein the light source comprises a laser.

8. The optical mouse of claim 1, wherein the image sensor is configured to detect light in a specular portion of a distribution of light reflected from the tracking surface.

9. An optical mouse, comprising:
a light-emitting diode configured to emit light having a wavelength in or near a blue region of a visible light spectrum toward a tracking surface;
an image sensor configured to detect light in a specular portion of a distribution of light reflected from the tracking surface;
one or more lenses configured to form an image of the tracking surface on the image sensor;
an optical diffuser disposed optically upstream of the tracking surface and configured to diffuse light from the light source that illuminates the tracking surface; and
a controller configured to receive image data from the image sensor and to identify a tracking feature in the image data.

10. The optical mouse of claim 9, wherein the optical diffuser is incorporated as part of the light source.

11. The optical mouse of claim 9, wherein the light source is configured to emit white light.

12. The optical mouse of claim 9, further comprising a lens disposed between the light source and the tracking surface, and wherein the optical diffuser comprises a diffusing surface on the lens.

13. The optical mouse of claim 9, wherein the optical diffuser is provided as a separate optical element from the light source and any lenses.

14. The optical mouse of claim 9, wherein the image sensor is configured to detect light in a specular portion of a distribution of light reflected from the tracking surface.

15. A method of tracking motion of an optical mouse, comprising:
directing a diffuse incident beam of light toward a tracking surface;
capturing a plurality of time-sequenced images of the tracking surface with an image sensor;
locating a tracking feature in the plurality of time-sequenced images of the tracking surface; and
tracking changes in location of the tracking feature across the plurality of time-sequenced images of the tracking surface.

16. The method of claim 15, wherein directing the incident beam of light toward the tracking surface comprises directing an incident beam of blue light toward the tracking surface.

17. The method of claim 15, wherein directing the incident beam of light toward the tracking surface comprises directing an incident beam of white light toward the tracking surface.

18. The method of claim 15, wherein the beam of light is diffused via an optical diffuser incorporated in a light source.

19. The method of claim 15, wherein the beam of light is diffused via a lens with a diffusing surface.

20. The method of claim 15, wherein the beam of light is diffused via a dedicated light diffuser disposed between the light source and the tracking surface.
